(19) United States
(12) Patent Application Publication
(10) Pub. No.: US 2018/0314298 A1
(43) Pub. Date: Nov. 1, 2018

(54) SCREEN PROTECTOR FOR AN ELECTRONIC DEVICE

(71) Applicant: OTTER PRODUCTS, LLC, Fort Collins, CO (US)

(72) Inventor: DALLAS M. SCAGGS, SAN DIEGO, CA (US)

(21) Appl. No.: 15/962,169

(22) Filed: Apr. 25, 2018

Related U.S. Application Data
(60) Provisional application No. 62/492,721, filed on May 1, 2017.

(51) Int. Cl. G06F 1/16

(52) U.S. Cl. CPC G06F 1/1637; G06F 2200/1634; G06F 2200/1633; G06F 1/1656

(57) ABSTRACT

A screen protector for protecting a screen of an electronic device is provided. The screen protector includes a transparent substrate having a first side and a second side opposite the first side, a first removable film covering the first side of the transparent substrate and a second removable film covering the second side of the transparent substrate, and a first alignment assistance tab positioned on the second removable film, wherein the first alignment assistance tab includes an affixing portion attaching the first alignment assistance tab to the second removable film and a user grip portion extending outwardly from the affixing portion.

### CROSS REFERENCE TO RELATED APPLICATIONS

This application claims priority to U.S. Provisional Application No. 62/492,721 filed May 1, 2017, the disclosure of which is hereby incorporated by reference in its entirety.

### BACKGROUND

The present disclosure relates generally to screen protectors for protecting a display screen of an electronic device and methods of applying a screen protector to an electronic device.

Personal electronic devices are commonly used for communication, entertainment purposes, as well as Internet access and a variety of other purposes. Examples of personal electronic devices include smartphones, tablet computers, gaming devices, audio players, video players, cameras, portable computers, two-way radios, GPS receivers, smart glasses, virtual reality glasses or helmets, masks or eyewear including an electronic display, health monitors, and/or other portable devices. Typical personal electronic devices may include a display screen for displaying information to a user, such as a touch-screen display.

Screen protectors are used to cover and protect a variety of materials and devices from, for example, scratches or dents that may be imparted during transport or use of the personal electronic device. Screen protectors may be used to protect, for example, the display screen of a personal electronic device to protect it from damage during normal day-to-day use. Screen protectors may be used alone or in combination with a protective case. Screen protectors are often transparent, and may permit the use of touch-sensitive and pressure-sensitive features of the electronic device through the screen protector.

A variety of screen protectors are known, each having properties that may be advantageous for some uses and disadvantageous for other uses. One exemplary form of screen protector includes glass and fortified glass screen protectors, such as the Alpha Glass® display screen protectors available from Otter Products, LLC, Fort Collins, Colo. Another exemplary form of screen protector includes a polymeric protective film, such as polyurethane protective films. Exemplary polymeric protective films can be found in U.S. Patent Application Publication 2016/01707416, the disclosures of which are hereby incorporated by reference in their entirety.

Screen protectors are typically provided with one or more temporary liner films attached to a front and/or back surface of the screen protector. The temporary liner films may protect the surfaces of the screen protector from fingerprints, smudges, debris, or dust, and/or may cover an adhesive layer to attach the screen protector to the personal electronic device.

Screen protectors are typically attached to a front surface of the personal electronic device by removing a first temporary liner film to expose the adhesive layer; carefully aligning the screen protector with a front surface of the electronic device while holding opposing sides of the screen protector; adhering the screen protector to the electronic device; and removing a second temporary liner film. However, it is often difficult to accurately align the screen protector with a front surface of the electronic device, resulting in a misplaced or misaligned screen protector. Moreover, users may inadvertently touch the exposed adhesive layer while touching the sides of the screen protector, resulting in undesirable fingerprints, smudges, or other markings on the screen protector. Finally, adhering the screen protector to the electronic device may result in air bubbles that may be introduced into the space between the screen protector and the electronic device, which may be visually undesirable or reduce the responsiveness of touch-sensitive and pressure-sensitive features of the display.

Improvements in one or more of the foregoing are desired.

### SUMMARY

In one example, a screen protector for an electronic device is provided. The screen protector includes a transparent substrate having a first side and a second side opposite the first side, a first removable liner covering at least a portion of the first side of the transparent substrate, and a second removable liner covering the second side of the transparent substrate. The screen protector also includes a first alignment assistance tab positioned on the second removable liner. The first alignment assistance tab includes an affixing portion attaching the first alignment assistance tab to the second removable liner and a user grip portion extending outwardly from the affixing portion.

In one example, a screen protector a for a touch-screen display of an electronic device is provided. The screen protector includes a transparent substrate having opposing first and second surfaces and a first removable liner covering at least a portion of the first surface of the transparent substrate and a second removable liner covering at least a portion the second surface of the transparent substrate. The screen protector also includes a first alignment assistance tab positioned on the second removable liner, wherein the first alignment assistance tab includes a first affixing portion attaching the first alignment assistance tab to the second removable liner and a first user grip portion extending outwardly from a central portion of the first affixing portion. The screen protector also includes a second alignment assistance tab positioned on the second removable liner, wherein the second alignment assistance tab includes a second affixing portion attaching the second alignment assistance tab to the second removable liner and a second user grip portion extending outwardly from an end portion of the second affixing portion.

In one example, a kit is provided. The kit includes a screen protector according to any of the above embodiments and instructions provided on the second removable liner for adhering the screen protector to the electronic device.

In one example a method for applying a screen protector to an electronic device having a display screen is provided. The method includes providing a screen protector according to any of the above embodiments. The method also includes removing the first removable liner from the first side of the transparent substrate, aligning a bottom edge of the transparent substrate with a bottom edge of the display screen while grasping the first alignment assistance tab, affixing a bottom portion of the transparent substrate to the display screen, flexing the transparent substrate into a curve shape, and then affixing a top portion of the transparent substrate to the display screen.

### BRIEF DESCRIPTION OF THE DRAWINGS

FIG. 1 illustrates an exemplary personal electronic device in a protective case with a screen protector installed.

FIG. 2 illustrates an exploded view of an exemplary personal electronic device and a screen protector.

FIG. 3A illustrates a top view of an exemplary screen protector with two alignment assistance tabs.

FIG. 3B illustrates a top view of another exemplary screen protector with two alignment assistance tabs.

FIG. 4 illustrates a cross-sectional view of a screen protector, first and second removable liners, and an exemplary alignment assistance tab.

FIG. 5 illustrates a cross-sectional view of a screen protector, first and second removable liners, and another exemplary alignment assistance tab.

FIG. 6 illustrates a cross-sectional view of a screen protector, first and second removable liners, and still another exemplary alignment assistance tab.

FIG. 7 illustrates an exemplary method of applying the screen protector of FIG. 3 to an electronic device.

FIG. 8 illustrates a top view of an exemplary screen protector with a single alignment assistance tab.

FIG. 9 illustrates an exemplary method of applying the screen protector of FIG. 8 to an electronic device.

### DETAILED DESCRIPTION

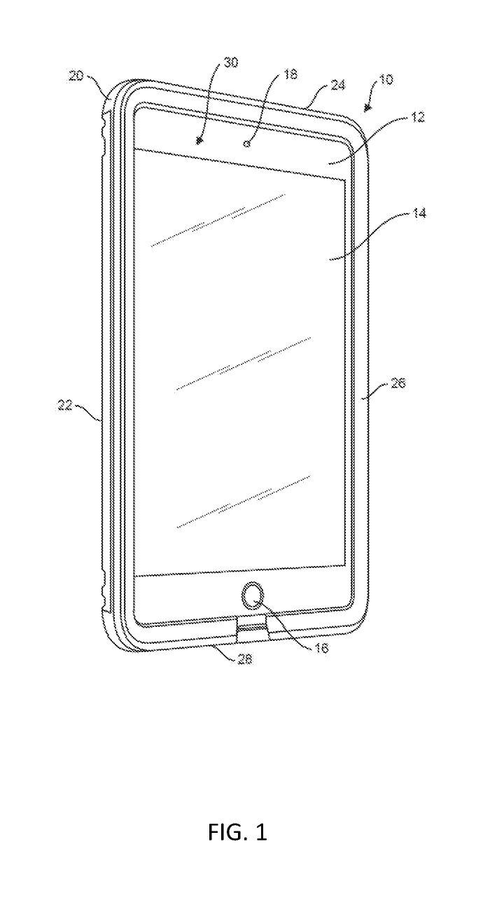

An exemplary electronic device 10 is illustrated in FIG. 1. Although a tablet computer is illustrated, in other embodiments, electronic device 10 may be a smart phone, a computer monitor, a gaming device, an audio player, a video player, a fitness device, a medical device, a camera, a portable computer, a two-way radio, a GPS receiver, and/or other electronic devices. Electronic device 10 includes a front surface 12 that illustratively includes a touch-screen display 14, one or more buttons 16, and front-facing camera 18.

Electronic device 10 is illustratively positioned in a protective case 20. Protective case 20 includes left side 22, top side 24, right side 26, and bottom side 28, sides 22, 24, 26, 28 defining a front aperture 30 allowing access to touch-screen display 12. An exemplary screen protector 30 is illustrated covering at least a portion of touch-screen display 12.

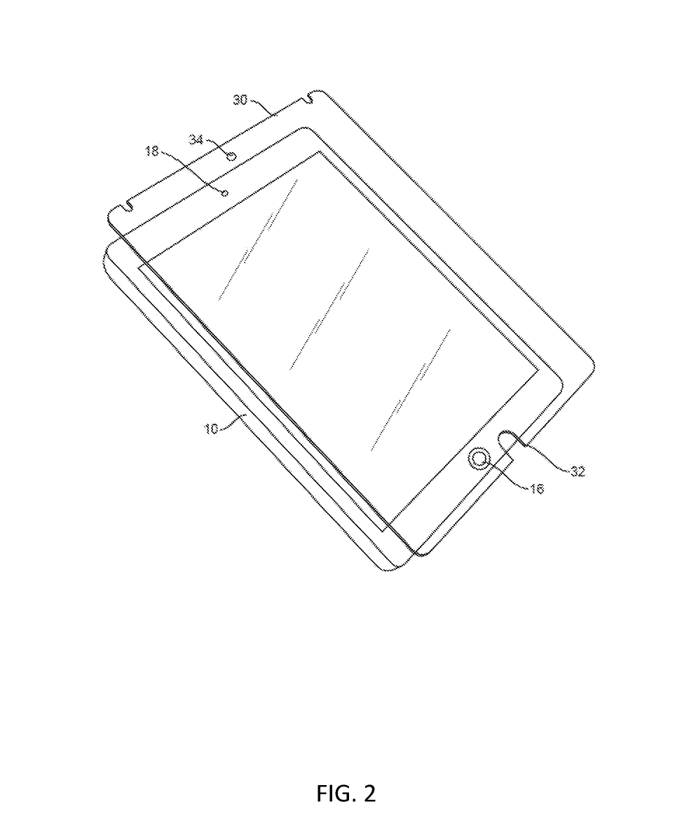

FIG. 2 illustrates an exploded view of an electronic device 10 and a screen protector 30. In some exemplary embodiments, screen protector 30 may include one or more recesses 32 and/or apertures 34, such as recess 32 to provide access to button 16 and aperture 34 aligned with camera 18. In other exemplary embodiments, screen protector 30 does not include any recesses 32, does not include any apertures 34, or does not include any recesses 32 or apertures 34.

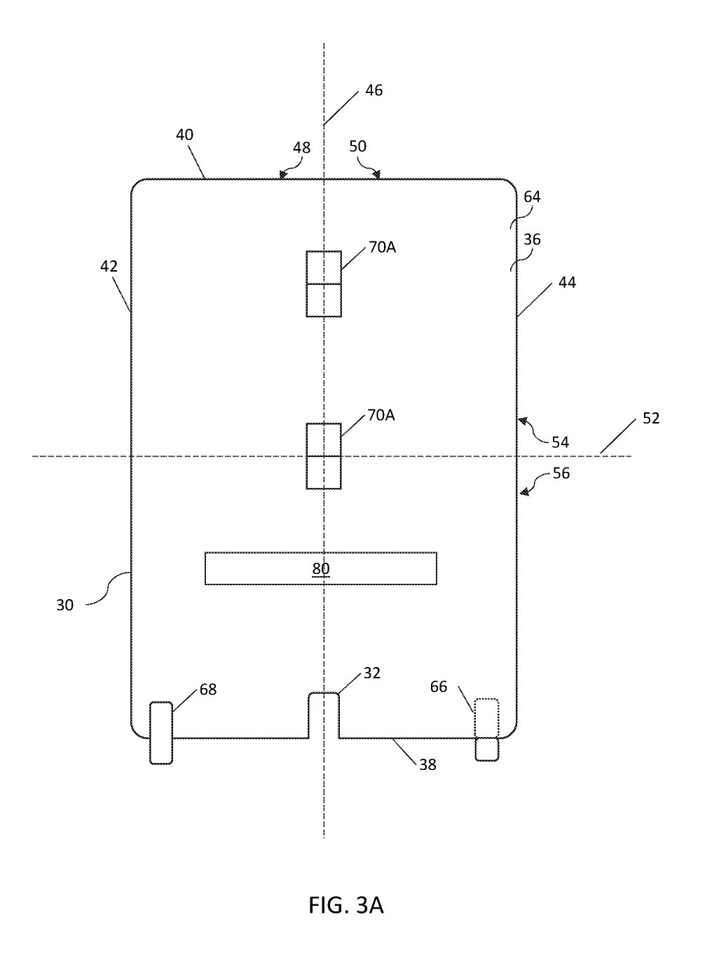

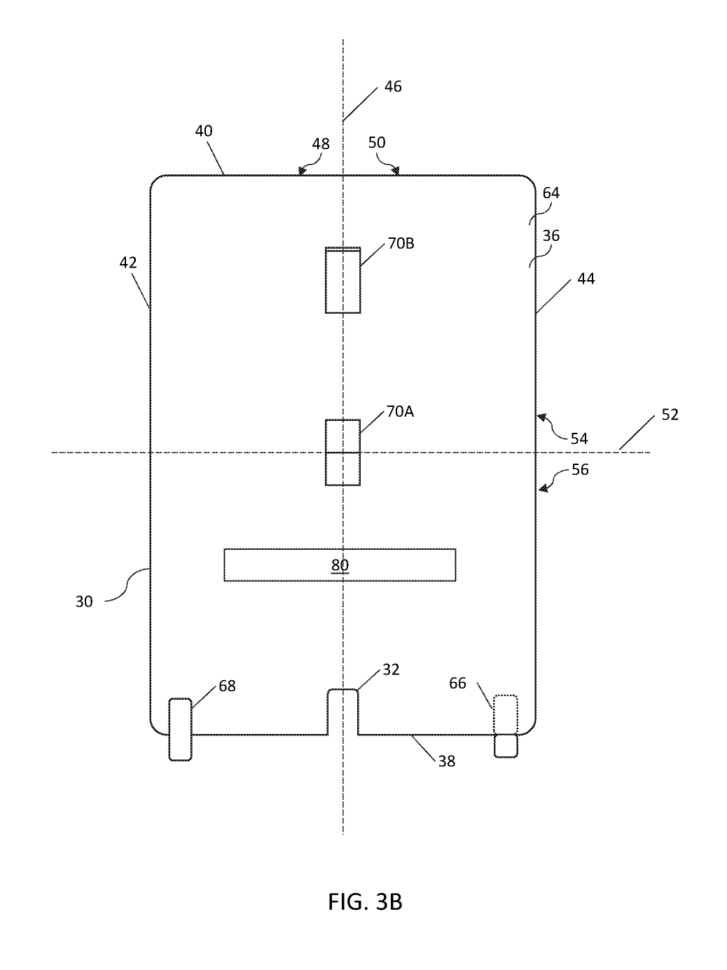

FIGS. 3A and 3B each illustrates a top view of an exemplary screen protector 30. Screen protector 30 is illustratively a transparent substrate, such as glass or polymer film, and includes a top surface 36 bounded by bottom edge 38, top edge 40 and opposing side edges 42, 44. Screen protector 30 has a major axis 46 dividing screen protector 30 into a left portion 48 on a first side of major axis 46 and a right portion 50 and a second side of major axis 46. Screen protector 30 has a minor axis 52 dividing screen protector 30 into an upper portion 54 above minor axis 52 and a lower portion 56 below minor axis 52. Although the front surface 12 and touch-screen display 14 of electronic device 10 are flat, and the screen protector 30 covering the touch-screen display 14 are each flat is the illustrated embodiments, in other embodiments screen protector 30 may be curved or include one or more curved edges to fit complimentary curved surfaces of electronic device 10.

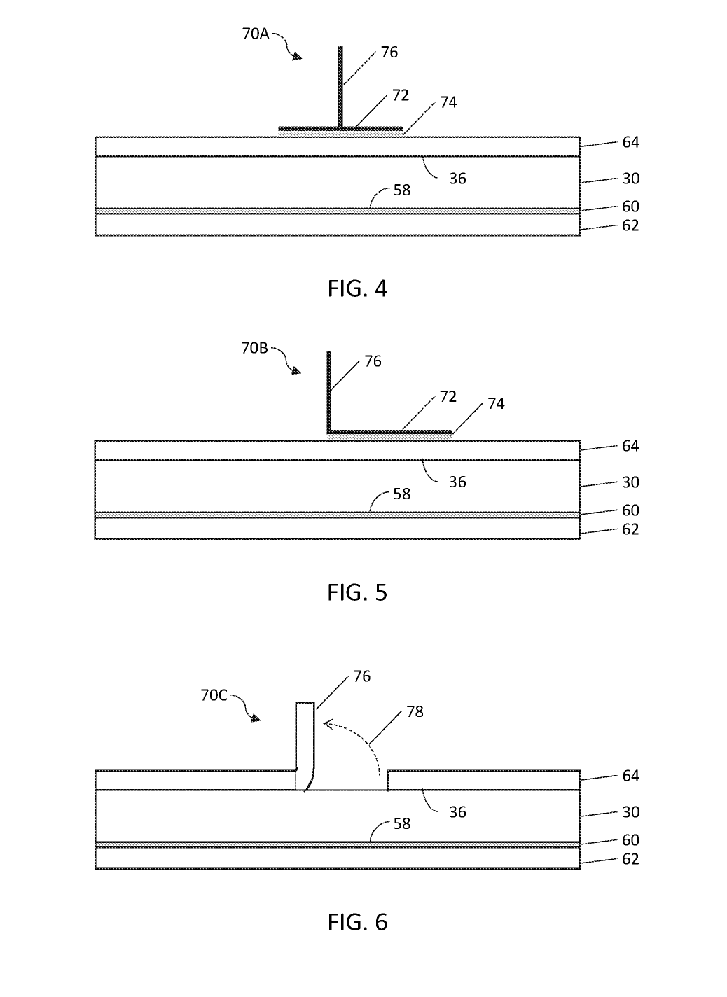

Referring next to sectional view of FIG. 4, screen protector 30 further includes a bottom surface 58 opposite top surface 36. An adhesive 60 covers at least a portion of bottom surface 58. In some exemplary embodiments, adhesive 60 covers substantially all of bottom surface 58. In other exemplary embodiments, adhesive 60 covers only a portion of bottom surface 58, such as a perimeter portion.

Adhesive 60 is selected to affix screen protector 30 to electronic device 10. In some exemplary embodiments, adhesive 60 is a permanent adhesive. In other exemplary embodiments, adhesive 60 allows for screen protector 30 to be removed from and reapplied to electronic device 10, or to another electronic device, multiple times. Exemplary adhesives include polyacrylate-based pressure-sensitive adhesives and adhesives comprising silicone elastomers.

As illustrated in FIG. 4, the bottom surface 58, including adhesive 60, are overlaid with a first removable liner 62. Removable liner 62 prevents adhesive 60 from adhering to a surface prior to removal of removable liner 62. Top surface 36 is overlaid with a second removable liner 64. Removable liners 62, 64 prevent bottom surface 58 and top surface 36 from being contaminated with dust, particulates, fingerprints, smudges, or other undesirable markings. Removable liners 62, 64 are illustratively formed from a suitable polymeric film.

Referring again to FIGS. 3A and 3B, removable liner 62 on the bottom surface 58 of screen protector 30 includes a first liner tab 66. First removable liner tab 66 is configured to be grasped and pulled by a user to separate first removable liner 62 from the bottom surface 58 of screen protector 30, thereby exposing the adhesive 60 to allow screen protector 30 to be adhered to electronic device 10. Removable liner 64 on the top surface 36 of screen protector 30 includes a second liner tab 68. Second removable liner tab 68 is configured to be grasped and pulled by a user to separate second removable liner 64 from the top surface 36 of screen protector 30, thereby exposing the top surface 36 of screen protector 30 for use by the user. Although first liner tab 66 is illustrated as positioned in a right portion 50 and lower portion 56 of screen protector 30 and second liner tab 68 is illustrated as positioned in a left portion 48 and lower portion 56 of screen protector 30, in other embodiments, first liner tab 66 and second liner tab 68 may be independently placed in any suitable position, including in left portion 48, right portion 50, upper portion 54, lower portion 56, or along one or both of major axis 46 and minor axis 52.

Screen protector 30 includes one or more alignment assistance tabs 70, 70A, 70B, 70C to assist a user in correctly placing screen protector 30 on electronic device 30. Alignment assistance tab 70 may be formed from any suitable material, such as a polyethylene terephthalate (PET) or other suitable plastic. In some exemplary embodiments, such as illustrated in FIG. 4 or FIG. 5 the alignment assistance tab 70A, 70B is affixed to the second removable liner 64. In other exemplary embodiments, such as illustrated in FIG. 6, the alignment assistance tab 70C is formed from the second removable liner 64.

Referring to FIG. 4, an exemplary alignment assistance tab 70A is illustrated. Alignment assistance tab 70A includes an affixing portion 72 configured to attach the alignment assistance tab 70A to the second removable liner 64. In one exemplary embodiment, the affixing portion 72 is generally oriented along or parallel to major axis 46. Affixing portion 72 is affixed to second removably liner 64 with a suitable adhesive 74.

Alignment tab 70A further includes a user grip portion 76 extending outwardly from the affixing portion 72. As illustrated in FIG. 4, user grip portion 76 extends from a position substantially in the center of affixing portion 72. In other embodiments, user grip portion 76 extends from a position not substantially in the center of affixing portion 72. User grip portion 76 provides a surface to which a user can grasp to manipulate screen protector 30 when installing screen protector 30 onto electronic device 10. In one exemplary embodiment, the user grip portion 76 is generally oriented along or parallel to minor axis 52. In some exemplary embodiments, the user grip portion 76 is flexible.

Referring next to the sectional view of FIG. 5, another exemplary alignment assistance tab 70B is illustrated. Alignment assistance tab 70B is similar to alignment tab 70A and similar part numbers are used to indicate similar features. User grip portion 76 of alignment assistance tab 70B extends from a position substantially at one end of affixing portion 72. In one exemplary embodiment, affixing portion 72 and user grip portion 76 form a single unitary piece, where the affixing portion 72 is adhered to second removable liner 74 and user grip portion 76 is not affixed to second removable liner 74. In another exemplary embodiment, affixing portion 72 is a separate element that is attached to affixing portion 72.

In some exemplary embodiments, the user grip portion 76 extends from an end of affixing portion 72 that is further from top edge 40 of screen protector 30. Without wishing to be held to any particular theory, it is believed that such an orientation allows for a user to pick up screen protector 30 by user grip portion 76 while allowing the force between second removable liner 30 and screen protector 30 to be spread over a wider area between alignment assistance tab 70B and top edge 40. This allows for better manipulation of the screen protector 30 without delaminating second removable film 64 from screen protector 30.

Referring to the sectional view of FIG. 6, another exemplary alignment assistance tab 70C is illustrated. Alignment assistance tab 70C is similar to alignment tab 70A and similar part numbers are used to indicate similar features. The user grip portion 76 of alignment assistance tab 70C is formed from a portion of second removable liner 64. The user grip portion 76 is not adhered to screen protector 30 and may be defined from second removable liner 64 through die cutting, laser cutting, perforations, or other suitable method. In one exemplary embodiment, a user grasps and end of user grip portion 76 and orients it substantially perpendicular to the second removable liner 64 by following the arcuate path shown by arrow 78.

Referring again to FIG. 3, in some exemplary embodiments, second removable liner 64 is affixed to a first alignment assistance tab 70 positioned at the intersection of the major axis 46 and the minor axis 52 and a second alignment assistance tab 70 positioned along the major axis 46 in the upper portion 54 above the minor axis 54.

In in the exemplary embodiment illustrated in FIG. 3A, the screen protector 30 includes two alignment tabs 70 of the same type, such as alignment tabs 70A as shown in FIG. 4A. As illustrated in FIG. 3A, both alignment tabs 70A are positioned on the major axis 46, with one of the alignment tabs 70A positioned also on the minor axis 52 and the other on the major axis 46 between the top edge 40 and the minor axis 52. In the exemplary embodiment illustrated in FIG. 3B, the screen protector 30 includes two alignment tabs 70 of different types, such as alignment tab 70A as shown in FIG. 4A and alignment tab 70B as shown in FIG. 4B. As illustrated in FIG. 3B, alignment tab 70A is positioned on the major axis 46 and the minor axis 52, while alignment tab 70B is positioned on the major axis 46 between the top edge 40 and the minor axis 52. Other suitable arrangements may also be used.

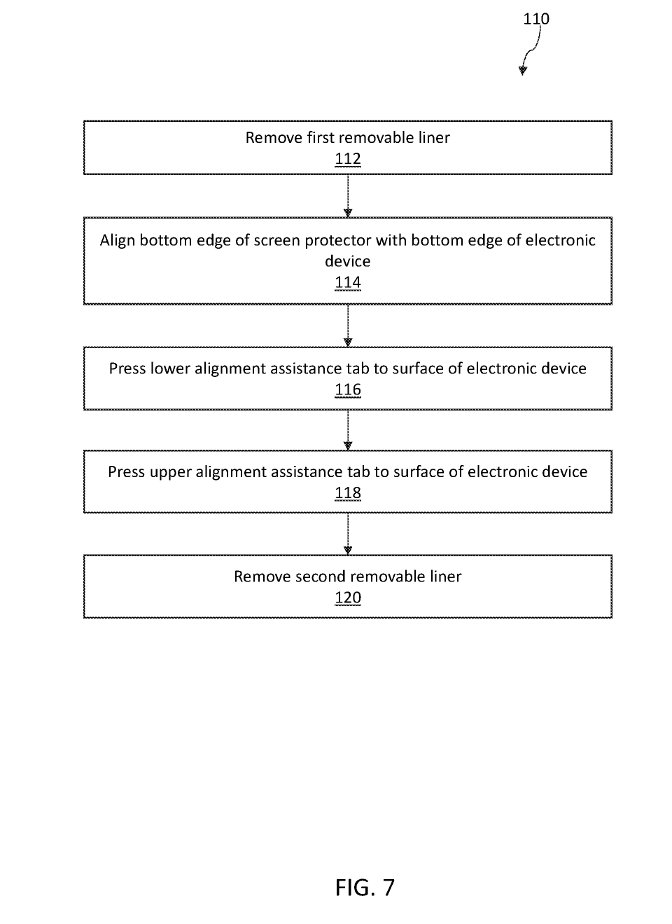

Referring next to FIG. 3 and FIG. 7, an exemplary method 110 of applying a screen protector 30 to an electronic device 10 using alignment assistance tabs 70 is provided. In some embodiments, method 100 allows a user to apply a screen protector 30 to an electronic device 10 without touching bottom edge 38, top edge 40, or opposing side edges 42, 44, reducing the amount of fingerprints, smudges, or other undesirable markings on bottom surface 58 of screen protector 30. Although FIG. 3 illustrates an alignment assistance tab 70 similar to alignment assistance tab 70A as shown in FIG. 4, a similar method may be used with other embodiments of alignment assistance tabs 70, including alignment assistance tabs 70B as shown in FIG. 4 and alignment assistance tabs 70C as shown in FIG. 5.

In block 112, the first removable liner 62 is removed, exposing the adhesive 60 of screen protector 30. In some exemplary embodiments, first removable liner 62 is removed by grasping an alignment assistance tab 70 with a first hand and grasping first liner tab 66 with a second hand to pull off first removable liner 62. In block 114, the bottom edge 38 of screen protector 30 is aligned with a bottom edge of the front surface 12 of electronic device 10 while grasping alignment assistance tab 70. Alignment assistance tab 70 is used to manipulate the screen protector 30 into the proper position. In some exemplary embodiments, the bottom edge 38 of screen protector is contacted with touch screen display 14 and bottom side 28 of protective case 20. In some instances, a grip portion 76 of an alignment assistance tab 70C may grasped by a user and rotated along the arcuate path shown by arrow 78 in FIG. 6.

Referring again to FIGS. 3 and 7, in block 116, a lower portion 56 of the screen protector 30 is adhered to the electronic device. In order to reduce the occurrence of air bubbles between screen protector 30 and front surface 12 of electronic device 10, in some embodiments the bottom edge 38 is kept fixed to electronic device 10 while a lower alignment assistance tab 70, such as the alignment assistance tab 70 positioned closer to bottom edge 38 in FIG. 3, is moved towards the screen 14. Once the portion of the screen protector 30 proximate the lower alignment assistance tab 70 contacts the screen 14, in block 118, an upper portion 58 of screen protector 30 is adhered to the electronic device by moving an upper alignment assistance tab 70, such as the tab positioned closer to top edge 40 in FIG. 30, towards the screen 14 until the screen protector 30 is fully adhered to electronic device 10.

In a more particular embodiment, in block 114 a user may grasp the lower alignment assistance tab 70 with one hand and the upper alignment assistance tab 70 with a second hand. By controlling two points, a user may be able to more easily align the screen protector 30 in its proper position. In block 116, a force can be applied to the upper alignment assistance tab away from the screen 14 as the lower alignment assistance tab 70 is brought towards the screen 14, flexing the screen protector 30 into a curved shape. Once the lower portion 56 of screen protector is adhered to the screen 14, in block 118 the user can then adhere the upper portion 54 by moving the upper alignment assistance tab towards the screen 14. In this embodiment, the opposite forces on the two alignment assistance tabs 70 in block 116 may result in a rolling-type motion that reduces the capture of air between screen protector 30 and electronic device 10.

In block 120, the second removable liner 64 is removed, exposing the top surface 36 of screen protector 30. In some exemplary embodiments, second removable liner 64 is removed by grasping a second liner tab 68 and pulling off second removable liner 64.

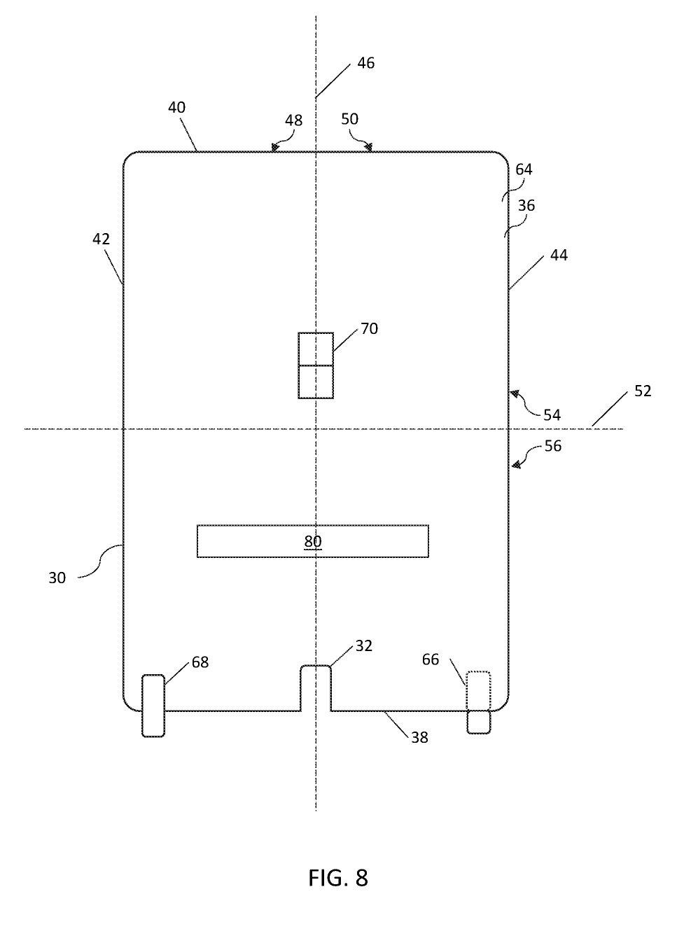

FIG. 8 illustrates a top view of an exemplary screen protector with a single alignment assistance tab. Referring to FIG. 8, in some exemplary embodiments second removable liner 64 is affixed to a first alignment assistance tab 70 positioned along the major axis 46 in the upper portion 54 above the minor axis 54.

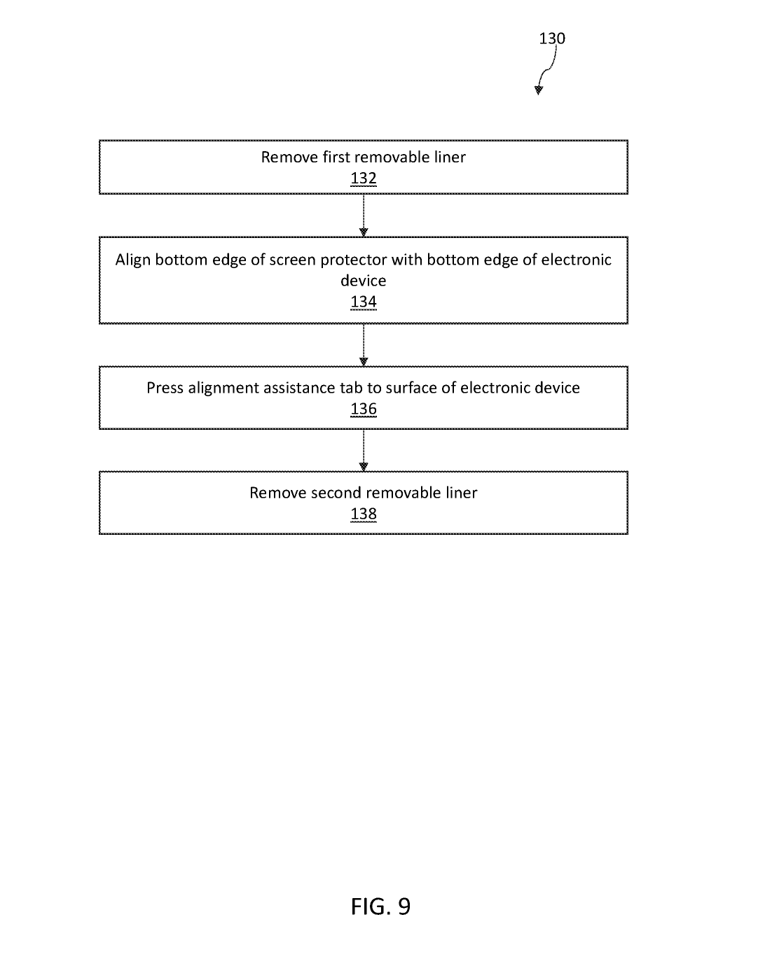

Referring next to FIG. 8 and FIG. 9, another exemplary method 130 of applying a screen protector 30 to an electronic device 10 using alignment assistance tabs 70 is provided. In some embodiments, method 130 allows a user to apply a screen protector 30 to an electronic device 10 without touching bottom edge 38, top edge 40, or opposing side edges 42, 44, reducing the amount of fingerprints, smudges, or other undesirable markings on bottom surface 58 of screen protector 30. Although FIG. 8 illustrates an alignment assistance tab 70 similar to alignment assistance tab 70A as shown in FIG. 4, a similar method may be used with other embodiments of alignment assistance tabs 70, including alignment assistance tabs 70B as shown in FIG. 4 and alignment assistance tabs 70C as shown in FIG. 5.

In block 132, the first removable liner 62 is removed, exposing the adhesive 60 of screen protector 30. In some exemplary embodiments, first removable liner 62 is removed by grasping an alignment assistance tab 70 with a first hand and grasping first liner tab 66 with a second hand to pull off first removable liner 62. In some instances, a grip portion 76 of an alignment assistance tab 70C may grasped by a user and rotated along the arcuate path shown by arrow 78 in FIG. 6.

In block 134, the bottom edge 38 of screen protector 30 is aligned with a bottom edge of the front surface 12 of electronic device 10 while grasping alignment assistance tab 70. In some exemplary embodiments, the bottom edge 38 of screen protector is contacted with touch screen display 14 and bottom side 28 of protective case 20. Alignment assistance tab 70 is used to manipulate the screen protector 30 into the proper position. As illustrated in FIG. 8, the alignment assistance tab 70 is positioned between the minor axis 52 and top edge 40, such that the tab 70 is misaligned with a center of gravity of the screen protector 30. This misalignment results in the lower portion 56 of screen protector 56 hanging lower than the upper portion 54 when the screen protector 30 is held solely by alignment assistance tab 70. This provides a desirable orientation for the user to align the bottom edge 38 relative to the bottom edge of the display 14 of electronic device 10 or the bottom side 28 of case 20.

Referring again to FIGS. 8 and 9, in block 136, the screen protector 30 is adhered to the electronic device. In order to reduce the occurrence of air bubbles between screen protector 30 and front surface 12 of electronic device 10, in some embodiments the bottom edge 38 is kept fixed to electronic device 10 while the alignment assistance tab 70 is brought towards screen 14. In a more particular embodiment, a user may apply a force to the top of second removable film 64 between the bottom edge 38 and alignment assistance tab 70 to flex the screen protector 30 into a curved shape, resulting in a rolling-type motion that reduces the capture of air between screen protector 30 and electronic device 10. In block 120, the second removable liner the second removable liner 64 is removed, exposing the top surface 36 of screen protector 30. In some exemplary embodiments, second removable liner 64 is removed by grasping a second liner tab 68 and pulling off second removable liner 64.

Referring next to FIGS. 3 and 8, in some exemplary embodiments, second removable liner 64 may include instructions 80 for installing screen protector 30. Exemplary instructions 80 include instructions similar to the descriptions provided for method 110 or method 130. In some exemplary embodiments, a kit is provided, the kit including a screen protector 30 including one or more alignment assistance tabs 70 as described above, and further including instructions 80 for installing screen protector 30 on to an electronic device 10.

The elements, components, and steps described herein are meant to exemplify some types of possibilities. In no way should the aforementioned examples limit the scope of the invention, as they are only exemplary embodiments.

The phrases “in some embodiments,” “in an exemplary embodiment,” “in one exemplary embodiment,” “in some exemplary embodiments,” “according to some embodiments,” “in the embodiments shown,” “in other embodiments,” “in some examples,” “in other examples,” “in some cases,” “in some situations,” “in one configuration,” “in another configuration,” and the like generally mean that the particular technique, feature, structure, or characteristic following the phrase is included in at least one embodiment of the present invention and/or may be included in more than one embodiment of the present invention. In addition, such phrases do not necessarily refer to the same embodiments or to different embodiments.

The foregoing disclosure has been presented for purposes of illustration and description. Other modifications and variations of the disclosed techniques may be possible in view of the above teachings. The embodiments described in the foregoing disclosure were chosen to explain the principles of the concept and its practical application to enable others skilled in the art to best utilize the invention. It is intended that the claims be construed to include other alternative embodiments of the invention, except as limited by the prior art.

What is claimed is:

1. A screen protector for an electronic device comprising:
a transparent substrate having a first side and a second side opposite the first side;
a first removable liner covering at least a portion of the first side of the transparent substrate and a second removable liner covering the second side of the transparent substrate; and
a first alignment assistance tab positioned on the second removable liner, wherein the first alignment assistance tab includes an affixing portion attaching the first alignment assistance tab to the second removable liner and a user grip portion extending outwardly from the affixing portion.

2. The screen protector of claim 1, wherein the transparent substrate includes an adhesive configured to affix the screen protector to the electronic device, the adhesive covering at least a portion of the first side.

3. The screen protector of claim 1, wherein the transparent substrate is formed from a glass or a fortified glass.

4. The screen protector of claim 1, wherein the transparent substrate is formed from a polymeric film.

5. The screen protector of claim 1, wherein the user grip portion is a flexible member extending from a position substantially in the center of the affixing portion.

6. The screen protector of claim 1, wherein the user grip portion is a flexible member extending from a position at an end of the affixing portion.

7. The screen protector of claim 1, wherein the first alignment assistance tab is formed from the second removable liner.

8. The screen protector of claim 1, wherein the first alignment assistance tab is positioned along a major axis of the screen protector, the major axis extending between a top edge and a bottom edge of the screen protector.

9. The screen protector of claim 8, wherein the first alignment assistance tab is positioned between a minor axis of the screen protector and the top edge of the screen protector, the minor axis extending between a left side edge and a right side edge of the screen protector.

10. The screen protector of claim 1 further comprising a second alignment assistance tab positioned on the second removable film, wherein the second alignment assistance tab includes an affixing portion attaching the alignment assistance tab to the second removable film and a user grip portion extending outwardly from the affixing portion.

11. The screen protector of claim 10, wherein the first alignment assistance tab and the second alignment assistance tab are positioned along a major axis of the screen protector, the major axis extending between a center of a top edge and a center of a bottom edge of the screen protector.

12. The screen protector of claim 11, wherein the second alignment assistance tab is positioned between the first alignment assistance tab and the top edge of the screen protector.

13. The screen protector of claim 12, wherein the first alignment assistance tab is positioned along a minor axis of the screen protector, the minor axis extending between a center of a left side edge and a center of a right side edge of the screen protector.

14. The screen protector of claim 1, further comprising instructions provided on the second removable liner for adhering the screen protector to an electronic device.

15. A screen protector for a touch-screen display of an electronic device, the screen protector comprising:
a transparent substrate having opposing first and second surfaces;
a first removable liner covering at least a portion of the first surface of the transparent substrate and a second removable liner covering at least a portion the second surface of the transparent substrate;
a first alignment assistance tab positioned on the second removable liner, wherein the first alignment assistance tab includes a first affixing portion attaching the first alignment assistance tab to the second removable liner and a first user grip portion extending outwardly from a central portion of the first affixing portion; and
a second alignment assistance tab positioned on the second removable liner, wherein the second alignment assistance tab includes a second affixing portion attaching the second alignment assistance tab to the second removable liner and a second user grip portion extending outwardly from an end portion of the second affixing portion.

16. The screen protector of claim 15, wherein the first alignment assistance tab and the second alignment assistance tab are positioned along a major axis of the screen protector, the major axis extending between a center of a top edge and a center of a bottom edge of the screen protector.

17. The screen protector of claim 16, wherein the second alignment assistance tab is positioned between the first alignment assistance tab and the top edge of the screen protector.

18. The screen protector of claim 15, wherein the transparent substrate is configured to flex between a flat configuration and a curved configuration.

19. A method of applying a screen protector to an electronic device having a display screen, the method comprising:
providing a screen protector, the screen protector including:
a transparent substrate having a first side and a second side opposite the first side;
a first removable liner covering at least a portion of the first side of the transparent substrate and a second removable liner covering the second side of the transparent substrate; and
a first alignment assistance tab positioned on the second removable liner, wherein the first alignment assistance tab includes an affixing portion attaching the first alignment assistance tab to the second removable liner and a user grip portion extending outwardly from the affixing portion;
removing the first removable liner from the first side of the transparent substrate;
aligning a bottom edge of the transparent substrate with a bottom edge of the display screen while grasping the first alignment assistance tab;
affixing a bottom portion of the transparent substrate to the display screen, flexing the transparent substrate into a curve shape, and then affixing a top portion of the transparent substrate to the display screen.

20. The method of claim 14, further comprising removing the second removable liner from the second side of the transparent surface.
